(19) United States
(12) Patent Application Publication
(10) Pub. No.: US 2024/0312082 A1
(43) Pub. Date: Sep. 19, 2024

(54) SYSTEM AND METHOD FOR GENERATING SINGLE-LINE DIAGRAMS AND THREE-LINE DIAGRAMS

(71) Applicant: Arka Energy Inc., Union City, CA (US)

(72) Inventors: Nikhil SHAJI, Kottayam (IN); Sreenivasa SUMADITHYA, Anantapur (IN); Yash RAO, New Delhi (IN)

(21) Appl. No.: 18/605,353

(22) Filed: Mar. 14, 2024

(30) Foreign Application Priority Data
Mar. 14, 2023 (IN) 202311017075

(51) Int. Cl. G06T 11/20; G06T 11/60

(52) U.S. Cl. CPC G06T 11/206; G06T 11/60; G06T 2200/24

(57) ABSTRACT

Embodiments of present disclosure relate to a system (100) and a method (400) for generating single-line diagrams and three line-diagrams automatically corresponding to received input. The system (100) includes a processor (102) configured to receive a pre-defined area of a region of interest (ROI) selected by a user by an input device 106, and receive parameters of a set of components associated with a solar installation at the ROI. In addition, the processor (102) generates a circuit diagram for the solar installation at the ROI corresponding to the received pre-defined area and the parameters. Further, the processor (102) renders on a graphical user interface (GUI), a visualization indicative of the generated circuit diagram over the ROI, where the visualization is any of the single-line diagram and the three-line diagram as preferred by a user.

### TECHNICAL FIELD

The present disclosure, in general, relates to designing of circuit diagrams. More particularly, it relates to system and method for automated rendering single-line diagrams (SLD) and three-line diagrams (3LD) of circuit diagrams.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

While generating single-line diagram of an electrical circuit, connection lines are drawn by hand manually. In addition, in order to draw a single-line diagram, a person must first draw the electrical circuit that is not visually appealing. Additionally, while checking or comparing electrical circuits with different inverter properties and different components, the previous electrical circuits need to be updated manually. Thus, a lot of time is required to check different inverter properties and different components. Further, workload is very high due to large number of connecting lines in the single line diagram, and different wiring paths of electrical circuit are different according rules of power system. Thus, there are high chances of error in drawing and connections of various components.

There is, therefore, a need to overcome the above drawback, limitations, and shortcomings associated with the existing line drawings techniques by providing a solution to automate process of designing line diagrams of circuits and optimize rendering time of a GPU.

### Objects of the Present Disclosure

Some of the objects of the present disclosure, which at least one embodiment herein satisfy are as listed herein below.

A general object of present disclosure is to overcome the above drawback, limitations, and shortcomings associated with the existing manual line drawing techniques, by providing a system and method for generating single-line diagrams (SLD) and three-line diagrams (3LD).

Another object of the present disclosure is to provide a system and method for generating SLD and 3LD automatically.

Another object of the present disclosure is to provide a system and method for generating SLD and 3LD that optimizes rendering time of GPU.

Another object of the present disclosure is to provide a system and method for generating circuit diagrams based on inverter properties.

Yet another object of the present disclosure is to provide a system and method for generating circuit diagrams, where performance is unaffected upon increasing number of geometry.

### SUMMARY

Various aspects of present disclosure relates to designing of circuit diagrams. More particularly, it relates to a method for automated rendering single-line diagrams (SLD) and three-line diagrams (3LD) of circuit diagrams based on inverter properties. The proposed method optimizes rendering time of GPU and performance of proposed method is unaffected upon increasing number of geometry.

An aspect of present disclosure pertains to a method for rendering line diagrams automatically. The method may include receiving at a processor, a first set of data packets pertaining to a pre-defined area of a region of interest (ROI), and the pre-defined area may be selected by a user. In addition, the processor may be configured for receiving a second set of data packets comprising one or more parameters of a set of components associated with a solar installation at the ROI, and generating a circuit diagram for the solar installation at the ROI by evaluating the first set of data packets and the second set of data packets. Further, the processor may be configured for rendering on a graphical user interface (GUI), a visualization indicative of the generated circuit diagram over the ROI, and the visualization may be any of a single-line diagram and a three-line diagram.

In an aspect, the set of components may include any or a combination of solar panel, inverter, DC disconnect, AC disconnect, meter, wire, charge controller, battery, junction box, combiner box, circuit breaker, fuse, load center, rapid shutdown, and surge device.

In an aspect, the one or more parameters may include any or a combination of attributes of inverter, temperature, attributes of solar panel, and a set of endpoints associated with the pre-defined area.

In an aspect, the processor may be configured for evaluating wiring between the set of components associated with the solar installation at the ROI, corresponding to the first set of data packets and the second set of data packets.

In an aspect, the processor may be configured for evaluating spacing between the set of components associated with the solar installation at the ROI, corresponding to the first set of data packets and the second set of data packets.

According to another aspect of present disclosure, a system to render a line diagram of a solar installation is disclosed. The system includes a processor configured to receive a first set of data packets pertaining to a pre-defined area of a region of interest (ROI), and the pre-defined area may be selected by a user. In addition, the processor may be configured to receive a second set of data packets comprising one or more parameters of a set of components associated with a solar installation at the ROI, and generate a circuit diagram for the solar installation at the ROI, upon evaluation the first set of data packets and the second set of data packets. Further, the processor may be configured to render on a graphical user interface (GUI), a visualization indicative of the generated circuit diagram over the ROI, and the visualization may be any of a single-line diagram and a three-line diagram.

Various objects, features, aspects, and advantages of the present disclosure will become more apparent from the following detailed description of preferred embodiments, along with the accompanying drawing figures in which like numerals represent like features.

### BRIEF DESCRIPTION OF THE ACCOMPANYING DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates a block diagram of a system for rendering line diagram on a graphical user interface, in accordance with an embodiment of the present disclosure.

FIG. 2A-2C illustrates exemplary interfaces, in accordance with an embodiment of the present disclosure.

FIG. 3 illustrates exemplary functional components of a processing engine of the system, in accordance with an embodiment of the present disclosure.

FIG. 4 illustrates a flow chart of a process for rendering line diagram, in accordance with an embodiment of the present disclosure.

FIG. 5 illustrates an exemplary computer system to implement proposed system, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims. Embodiments of present disclosure relates to designing of circuit diagrams. More particularly, it relates to a method for automated rendering single-line diagrams (SLD) and three-line diagrams (3LD) of circuit diagrams based on inverter properties.

According to an embodiment of present disclosure a method for rendering a line diagram is disclosed. The method includes receiving at a processor, a first set of data packets pertaining to a pre-defined area of a region of interest (ROI), and the pre-defined area may be selected by a user. In addition, the processor may be configured for receiving a second set of data packets comprising one or more parameters of a set of components associated with a solar installation at the ROI, and generating a circuit diagram for the solar installation at the ROI by evaluating the first set of data packets and the second set of data packets. Further, the processor may be configured for rendering on a graphical user interface (GUI), a visualization indicative of the generated circuit diagram over the ROI, and the visualization may be any of a single-line diagram and a three-line diagram.

In an embodiment, the set of components may include any or a combination of solar panel, inverter, DC disconnect, AC disconnect, meter, wire, charge controller, battery, junction box, combiner box, circuit breaker, fuse, load center, rapid shutdown, and surge device.

In an embodiment, the one or more parameters may include any or a combination of attributes of inverter, temperature, attributes of solar panel, and a set of endpoints associated with the pre-defined area.

In an embodiment, the processor may be configured for evaluating wiring between the set of components associated with the solar installation at the ROI, corresponding to the first set of data packets and the second set of data packets.

In an embodiment, the processor may be configured for evaluating spacing between the set of components associated with the solar installation at the ROI, corresponding to the first set of data packets and the second set of data packets.

According to another embodiment of present disclosure, a system to render a line diagram of a solar installation is disclosed. The system includes a processor configured to receive a first set of data packets pertaining to a pre-defined area of a region of interest (ROI), and the pre-defined area may be selected by a user. In addition, the processor may be configured to receive a second set of data packets comprising one or more parameters of a set of components associated with a solar installation at the ROI, and generate a circuit diagram for the solar installation at the ROI, upon evaluation the first set of data packets and the second set of data packets. Further, the processor may be configured to render on a graphical user interface (GUI), a visualization indicative of the generated circuit diagram over the ROI, and the visualization may be any of a single-line diagram and a three-line diagram.

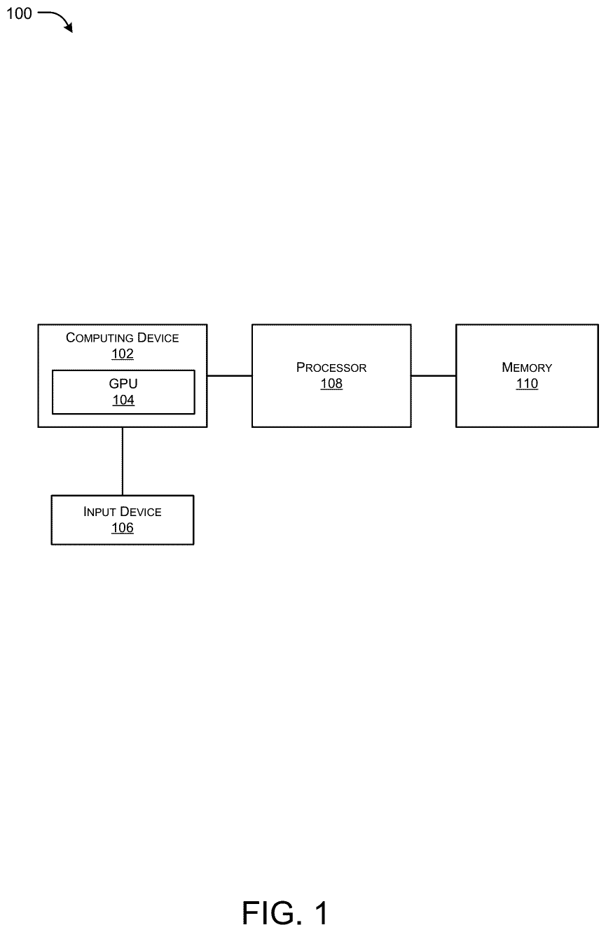

FIG. 1 illustrates a block diagram of a system for rendering line diagram on a graphical user interface, in accordance with an embodiment of the present disclosure.

As illustrated, a system 100 for rendering single-line diagrams (SLD) and three-line diagrams (3LD) is disclosed. The system 100 includes a computing device 102 having a graphical processing unit (GPU) 104, and the computing device 102 can be operatively coupled to an input device 106. The computing device 102 may correspond to various types of computing devices, such as, but not limited to, a desktop computer, a laptop, a PDA, a mobile device, a smartphone, a tablet computer, and the like. The input device may be selected from a group consisting of a mouse, keyboard, a joystick, or the like. The graphical processing unit (GPU) 104 acts as a processing unit for all graphical user interfaces (GUI) in the computing device. In an exemplary embodiment, the GPU renders graphics data inside the GUI and ensures that graphical data is displayed to the computing device 102. In addition, the GPU can be used for memory-intensive tasks like rendering images and videos, animations, and CAD tasks.

In an embodiment, the system 100 includes a processor 108 that can be communicatively coupled to the computing device 102, and a memory 110. The processor 108 includes suitable logic, circuitry, and/or interfaces that are operable to execute one or more instructions stored in the memory 114 to perform pre-determined operation. The memory 110 may be operable to store the one or more instructions. The processor 108 may be implemented using one or more processor technologies known in the art. Examples of the processor 108 include but are not limited to, an x86 processor, a RISC processor, an ASIC processor, a CISC processor, an Arduino Uno board, an ESP 8266 node microcontroller, or any other processor.

The memory 110 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the memory 110 includes the one or more instructions that are executable by the processor 108 to perform specific operations. It will be apparent to a person having ordinary skill in the art that the one or more instructions stored in the memory 110 enable multiple components of the system 100 to perform predetermined operations.

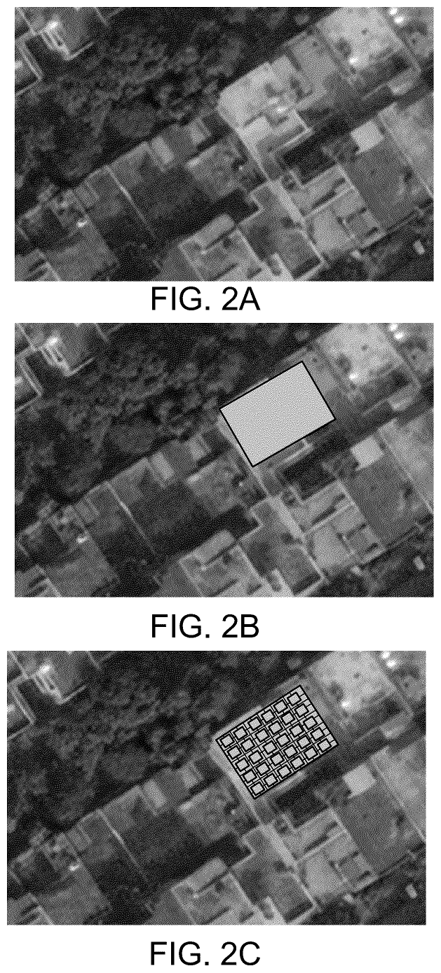

In an embodiment, the processor may be configured to receive, a first set of data packets pertaining to a pre-defined area of a region of interest (ROI), as shown in FIGS. 2A and 2B. The ROI can be roof of home, office, industry, or the like, where solar installation is required. The pre-defined area of the ROI may be selected by a user by the input device 106 on the computing device. In addition, the processor 108 may be configured for receiving, a second set of data packets. The second set of data packets includes one or more parameters (interchangeably referred to as parameters, hereinafter) of a set of components associated with the solar installation at the ROI.

In an embodiment, the parameters may include any or a combination of attributes of inverter, temperature, attributes of solar panel, and a set of endpoints associated with the pre-defined area. In an exemplary embodiment, number of solar panels required in the selected ROI can be evaluated by generating a visualization, as shown in FIG. 2C. In some embodiments, the parameters may be received automatically from the memory corresponding the area and required number of solar panels. In some embodiments, the parameters may be received from user, or user may input parameters by selecting from the GUI.

In an exemplary embodiment, the inverter converts direct current (DC) electricity, generated by the solar panels to alternating current (AC) electricity, which electrical grid uses. In addition, the inverter accomplishes the DC-to-AC conversion by switching the direction of a DC input back and forth very rapidly. There are several types of inverters that might be installed as part of a solar installation, the inverter can be any or a combination of single central inverter, micro-inverter, and string inverter.

In an exemplary embodiment, the solar panels actually made up of groups of photovoltaic (PV) cells that take energy from Sun to produce electricity. These photovoltaic cells convert sunlight into electricity by establishing an electric field between a positive charge on one side and a negative charge on the other. The PV cells are arranged together in groups to form the solar panels that can generate electricity The solar panels can also be arranged together to form a solar array. The more panels are uses, the more energy can be generated. This size of the solar panels and arrangement of the solar panels can be taken as attributes of the solar panel required for solar installation in the ROI.

In an exemplary embodiment, the temperature can be environment temperature, temperature of solar panels, and the like.

In an embodiment, the set of components may include any or a combination of solar panel, inverter, DC disconnect, AC disconnect, meter, wire, charge controller, battery, junction box, combiner box, circuit breaker, fuse, load center, rapid shutdown, and surge device.

In an embodiment, the processor 108 may be configured to generate a circuit diagram for the solar installation at the ROI upon evaluation of the first set of data packets and the second set of data packets. Additionally, the processor 108 may be configured to render on the graphical user interface (GUI), visualization indicative of the generated circuit diagram over the ROI. The visualization is any of the single-line diagram and the three-line diagram. The single-line diagram or the three-line diagram as preferred by the user from the GUI, is generated by the system and displayed on the GUI.

In an exemplary embodiment, the graphical receives input (i.e. components, parameters, etc.) from the user, the user can be a customer, a service provider or the like. The GUI may be presented to the user on the associated computing device via a web browser or a native application executing on the computing device. The computing device may be connected to a network, for example, a wired local area network (LAN), a wireless local area network (WLAN), personal area network (PAN), wide area network (WAN), enterprise private network (EPN), and internet, or the like.

In an exemplary embodiment, the single-line diagram provides the visual representation of an electrical system (i.e. circuit diagram) of the solar panel installation in the ROI including the components and wires. Further, if any changes are made to input data or preferences of a customer, the system may update the single-line diagram and the three-line diagrams to reflect those changes. The single-line diagram and the three-line diagram are visual representation of the circuit diagram for the solar installation at the ROI. Thus, the embodiments described herein provide techniques to dynamically generate single-line diagram and the three-line diagram for viewing in real-time during a design phase of the solar installations, as inverter properties, temperature, solar panels, or the like are changed or added to the design in real-time. The circuit diagram may be dynamically modified while the components and the parameters are modified.

In an exemplary embodiment, to generate the single-line diagram, the system may receive list of components and parameters required for solar installations. As the system receives each components in the list, the system may identify a graphical object representative of a corresponding component in the list and dynamically add the graphical object to the single-line diagram. Thus, the single-line diagram presents a real-time visual representation of the circuit diagrams that are part of the list at any given time. Further, as changes are made to the list, the system may dynamically update the graphical objects, such that the single-line diagram is updated to reflect the changes as the changes are made. Furthermore, connections between the graphical objects of the single-line diagram may be generated while the graphical objects corresponding to the components of the list are generated. In some embodiments, the connections may be generated after all graphical objects are generated and rendered in the single-line diagram. In some embodiments, rendering of the connections between components of the single-line diagram may be performed concurrently with generating and rendering the graphical objects or may be performed as separate operations.

In an embodiment, the processor 108 may be configured for evaluating, wiring between the set of components associated with the solar installation at the ROI, corresponding to the first set of data packets and the second set of data packets. Additionally, the processor may be configured for evaluating spacing between the set of components associated with the solar installation at the ROI, corresponding to the first set of data packets and the second set of data packets.

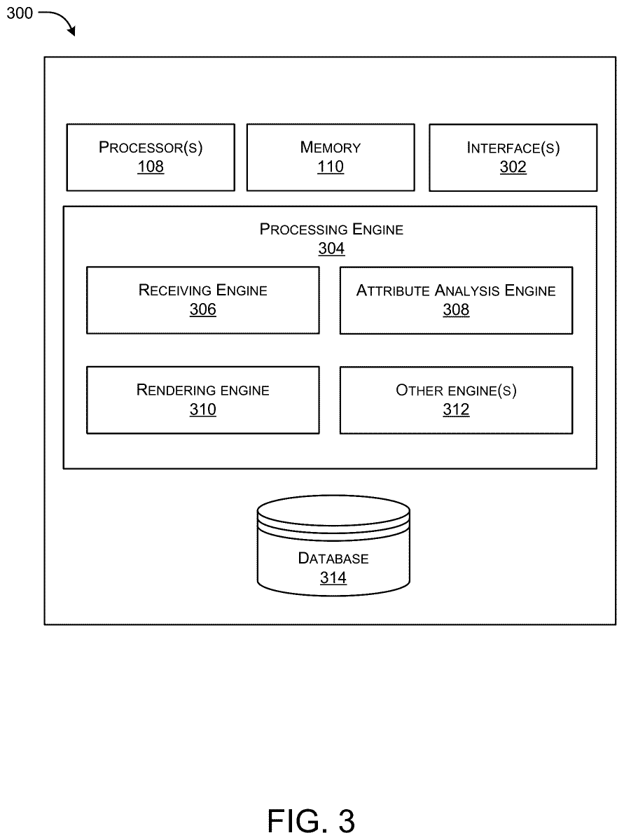

FIG. 3 illustrates exemplary functional components of a processing engine of system 100, in accordance with an embodiment of the present disclosure.

In an embodiment, a system 100 includes a processor 108, a memory 110, and one or more interface(s) 302. The interface 302 may include a variety of interfaces, for example, interfaces for data input and output devices, referred to as I/O devices, storage devices, and the like. The interface 302 may also provide a communication pathway for one or more components of system 100. Examples of such components include, but are not limited to, a processing engine 304 and a database 314.

The processing engine 304 is provided with the processor 102, and it can be implemented as a combination of hardware and programming (for example, programmable instructions) to implement one or more functionalities of the processing engine 304. In examples described herein, such combinations of hardware and programming may be implemented in several different ways. For example, the programming for the processing engine 304 may be processing unit executable instructions stored on a non-transitory machine-readable storage medium, and the hardware for the processing engine 304 may include a processing resource (for example, one or more processors), to execute such instructions. In the present examples, the machine-readable storage medium may store instructions that, when executed by the processing resource, implement the processing engine 304. In such examples, the processing engine 304 can include the machine-readable storage medium storing the instructions and the processing resource to execute the instructions, or the machine-readable storage medium may be separate but accessible to the processor 102 and the processing resource. In other examples, the processing engine 304 can be implemented by electronic circuitry.

In an embodiment, the processing engine 304 includes a receiving engine 306, an attribute analysis engine 308, a rendering engine 310, and other engine(s) 312. The other engine(s) 312 can implement functionalities that supplement applications or functions performed by system 100 or the processing engine 304. It would be appreciated that the modules being described are only exemplary modules and any other modules or sub-modules may be included as part of system 100. These units too may be merged or divided into super-modules or sub-modules as may be configured. In addition, database 314 includes data that is either stored or generated as a result of functionalities implemented by any of the components of system 100.

In an exemplary embodiment, the processing engine 304 groups line information of all components and are used to create single line diagram and three line diagram using LineSegments, a functionality of Three.js. This way the performance of the system is unaffected corresponding to number of geometry. Three.js has a rich graphics system that provides features such as 3D libraries, 2D and 3D geometry built from polygonal meshes, a scene graph with hierarchal objects and transformations, materials, textures, lights, real-time shadows, user-defined programmable shades, and a flexible rendering system that enables multipass and deferred techniques for advanced special effects. In addition, the Three.js comes with many prebuilt geometry types that represent common shapes. This includes simple solids such as cubes, spheres, and cylinders, more complex parametric shapes like extrusions and path-based shapes, flat 2D shapes rendered in 3D space, such as circles, squares, rings, and even 3D extruded text generated from text strings. Three.js also supports drawing 3D points and lines.

In some embodiments, the receiving engine 306 may be configured to receive a first set of data packets and a set of data packets. The first set of data packets pertains to a pre-defined area of a region of interest (ROI), and the second set of data packets may include parameters of a set of components associated with the solar installation at the ROI.

In some embodiments, the attribute analysis engine 308 may be configured to extract a set of endpoints of the pre-defined area and values of each parameter of the set of components, and correspondingly evaluate spacing between the set of components associated with the solar installation at the ROI. In addition, based on the extracted set of endpoints values of each parameter of the set of components, the processor evaluates wiring between the set of components associated with the solar installation at the ROI.

In some embodiments, rendering engine 310 may be configured to generate a circuit diagram for the solar installation at the ROI by evaluating the first set of data packets and the second set of data packet. Further, the rendering engine 310 renders on a GUI, visualization indicative of the generated circuit diagram over the ROI. The visualization can be any of a single-line diagram or a three-line diagram. The user may selects type of visualization SLD or 3LD from the GUI.

In an exemplary embodiment, widgets may be depicted on the GUI to provide interactive to generate the single-line drawing and the three-line drawings.

For example, user selects an area on a computing device 104 through an input device 106, where a solar installation is required. Upon selection of the area by the user, a visualization depicting a number of solar panels of required size fitted in the area may be rendered on a graphical user interface (GUI). Further, corresponding to the number of solar panels of required size and the received parameters from the user or from a dataset, a circuit diagram can be generated and rendered on the GUI of the computing device. Thus, the proposed system enables the user to get a quick view of the circuit diagram required to be set up in the area where solar installation is required.

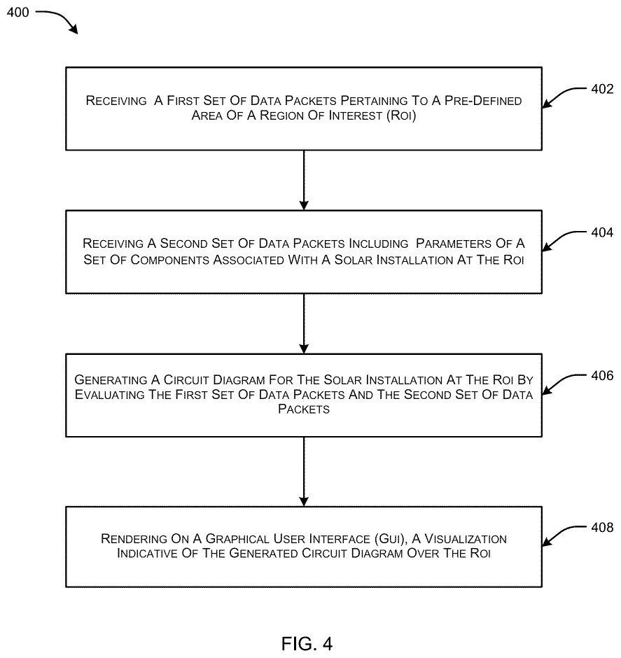

FIG. 4 illustrates a flow chart of a process for rendering line diagram, in accordance with an embodiment of the present disclosure. As illustrated, a flow chart 400 is disclosed, at block 402, a method 400 includes receiving, at a processor 108, a first set of data packets pertaining to a pre-defined area of a region of interest (ROI). The pre-defined area is selected by a user.

As illustrated, at block 404, the method 400 includes receiving at the processor 108, a second set of data packets comprising one or more parameters of a set of components associated with a solar installation at the ROI.

As illustrated, at block 406, the method 400 includes generating by the processor 108 a circuit diagram for the solar installation at the ROI by evaluating the first set of data packets and the second set of data packets.

As illustrated, at block 408, the method 400 includes rendering on a graphical user interface (GUI), a visualization indicative of the generated circuit diagram over the ROI. The visualization may be any of a single-line diagram or a three-line diagram.

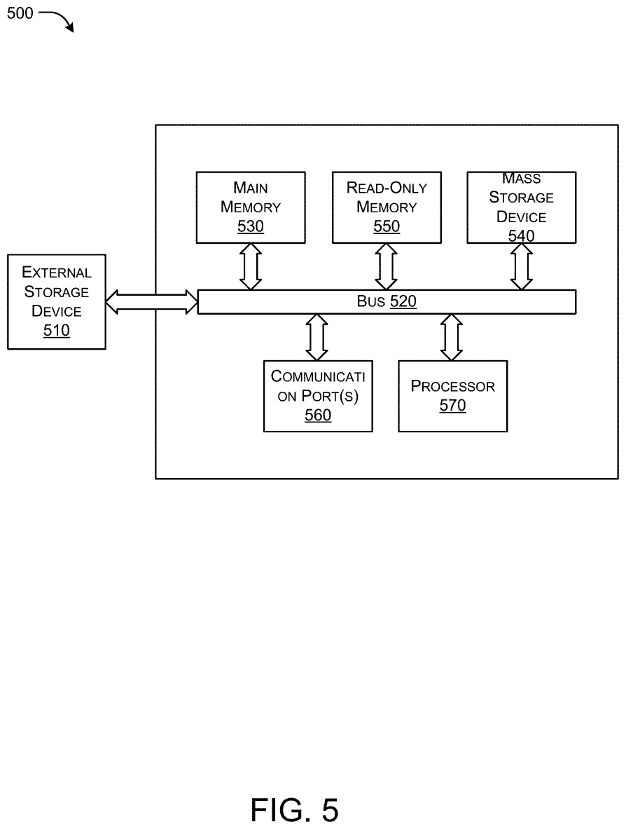

FIG. 5 illustrates an exemplary computer system to implement proposed system, in accordance with an embodiment of the present disclosure. As shown in FIG. 5, a computer system 500 can include an external storage device 510, a bus 520, a main memory 530, a read only memory 540, a mass storage device 550, communication port 560, and a processor 570. A person skilled in the art will appreciate that the computer system may include more than one processor and communication ports. Examples of processor 570 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 570 may include various modules associated with embodiments of the present invention. Communication port 560 can be any of an RS-232 port for use with a modem-based dialup connection, a 10/100 Ethernet port, a Gigabit or 10 Gigabit port using copper or fibre, a serial port, a parallel port, or other existing or future ports. Communication port 560 may be chosen depending on a network, such a Local Area Network (LAN), Wide Area Network (WAN), or any network to which computer system connects. Memory 530 can be Random Access Memory (RAM), or any other dynamic storage device commonly known in the art. Read-only memory 540 can be any static storage device(s) e.g., but not limited to, a Programmable Read Only Memory (PROM) chips for storing static information e.g., start-up or BIOS instructions for processor 570. Mass storage 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 520 communicatively couples processor(s) 570 with the other memory, storage, and communication blocks. Bus 520 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 570 to software system.

Optionally, operator and administrative interfaces, e.g., a display, keyboard, and a cursor control device, may also be coupled to bus 520 to support direct operator interaction with a computer system. Other operator and administrative interfaces can be provided through network connections connected through communication port 560. The external storage device 510 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Embodiments disclosed herein provide system and method to streamline process for generating base circuit designs (desired layouts, and diagrams (e.g., single-line diagram and three line diagrams) by reducing user's input. Also, proposed system and method optimizes rendering time of GPU.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced.

Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to those having ordinary skill in the art.

### Advantages of the Invention

The present disclosure provides a system and method for generating SLD and 3LD automatically.

The present disclosure provides a system and method for generating SLD and 3LD that optimizes rendering time of GPU.

The present disclosure provides a system and method for generating circuit diagrams based on inverter properties.

The present disclosure provides a system and method for generating circuit diagrams, where performance is unaffected upon increasing number of geometry.

We claim:

1. A method comprising:
receiving, at a processor, a first set of data packets pertaining to a pre-defined area of a region of interest (ROI), wherein the pre-defined area is selected by a user;
receiving, at the processor, a second set of data packets comprising one or more parameters of a set of components associated with a solar installation at the ROI;
generating, a circuit diagram for the solar installation at the ROI by evaluating the first set of data packets and the second set of data packets; and
rendering, on a graphical user interface (GUI), a visualization indicative of the generated circuit diagram over the ROI, wherein the visualization is any of a single-line diagram and a three-line diagram.

2. The method as claimed in claim 1, wherein the set of components comprises any or a combination of solar panel, inverter, DC disconnect, AC disconnect, meter, wire, charge controller, battery, junction box, combiner box, circuit breaker, fuse, load center, rapid shutdown, and surge device.

3. The method as claimed in claim 1, wherein the one or more parameters comprise any or a combination of attributes of inverter, temperature, attributes of solar panel, and a set of endpoints associated with the pre-defined area.

4. The method as claimed in claim 1, wherein, the processor is configured for evaluating, wiring between the set of components associated with the solar installation at the ROI, corresponding to the first set of data packets and the second set of data packets.

5. The method as claimed in claim 1, wherein, the processor is configured for evaluating, spacing between the set of components associated with the solar installation at the ROI, corresponding to the first set of data packets and the second set of data packets.

6. A system to render a line diagram of a solar installation, the system comprising:
a processor; and
a memory storing instructions that, when executed by the processor, cause the processor to perform:
receive, a first set of data packets pertaining to a pre-defined area of a region of interest (ROI), wherein the pre-defined area is selected by a user;
receive, a second set of data packets comprising one or more parameters of a set of components associated with a solar installation at the ROI;
generate, a circuit diagram for the solar installation at the ROI, upon evaluation the first set of data packets and the second set of data packets; and
render, on a graphical user interface (GUI), a visualization indicative of the generated circuit diagram over the ROI, wherein the visualization is any of a single-line diagram and a three-line diagram.

7. The system as claimed in claim 6, wherein the set of components comprises any or a combination of solar panel, inverter, DC disconnect, AC disconnect, meter, wire, charge controller, battery, junction box, combiner box, circuit breaker, fuse, load center, rapid shutdown, and surge device.

8. The system as claimed in claim 6, wherein the one or more parameters comprise any or a combination of attributes of inverter, temperature, attributes of solar panel, and a set of endpoints associated with the pre-defined area.

9. The system as claimed in claim 6, wherein, the processor is configured for evaluating, wiring between the set of components associated with the solar installation at the ROI, corresponding to the first set of data packets and the second set of data packets.

10. The system as claimed in claim 6, wherein, the processor is configured to evaluate, spacing between the set of components associated with the solar installation at the ROI, corresponding to the first set of data packets and the second set of data packets.
